(19) United States
(12) Patent Application Publication
(10) Pub. No.: US 2012/0070809 A1
(43) Pub. Date: Mar. 22, 2012

(54) Lesson learning system and method thereof

(75) Inventors: Chaucer Chiu, Taipei (TW); Tao Zhou, Shanghai (CN)

(73) Assignee: INVENTEC CORPORATION, Taipei (TW)

(21) Appl. No.: 12/928,578

(22) Filed: Dec. 14, 2010

(30) Foreign Application Priority Data
Sep. 21, 2010 (TW) 099131986

(51) Int. Cl. G09B 1/00

(52) U.S. Cl. 434/169

(57) ABSTRACT

A lesson learning system and method thereof are provided. The mechanism displays a lesson with article information and new words for the user to browse. It allows the user to click a word to show the correct order of strokes of the word. The invention further detects the order of strokes in any input so as to compare with the correct order of strokes, thereby giving a score information. The mechanism helps enhance the efficiency of learning new words.

### BACKGROUND OF THE INVENTION

1. Field of Invention

The invention relates to a learning system and method thereof, in particular, to a learning system and method that allows the user to click a new word in a lesson for learning how to write the word and evaluate the learning.

2. Related Art

With the popularity of computers, a lot of teaching materials have been digitized in recent years. Even though most of the digital teaching materials can provide ample pictures, text or videos, they still lack interactions with learners.

Generally speaking, digital teaching materials contain a database for holding various pictures, text, or videos of data. When a user uses the digital teaching materials, he can obtain the corresponding data from the database for learning. Although this method can satisfy many courses, it is far from sufficient for learning lessons. In particular, the lack of interactions with users prevents the users from learning lessons efficiently.

In view of this, some vendors allow the user to practice new words by writing so that the user can increase the learning efficiency by practicing, in addition to reading. This can indeed increase the fun and interactions in learning lessons. However, the user still cannot effectively know the correct way of writing a word. Moreover, this method does not provide suggestions to the user. Therefore, the learning efficiency still cannot be effectively increased.

In summary, the prior art always has the problem that no evaluation or suggestion can be provided for the learning of writing new words. It is thus imperative to provide a better solution.

### SUMMARY OF THE INVENTION

In view of the foregoing, the invention discloses a lesson learning system and the method thereof.

The disclosed lesson learning system includes: a lesson database, a displaying module, a learning module, and a scoring module. The lesson database stores a plurality of lessons, each of which contains article information, new words, and stroke information of each new word. The displaying module selectively loads one of the lessons and shows the article information and new words therein. After clicking one of the new words, the learning module generates a playing area to play the stroke information of the corresponding new word. It also generates a following area to detect and display user's input strokes therein. After the input strokes detected in the following area, the scoring module compares them with the stroke information of the clicked new word, thereby generating a score information.

The disclosed lesson learning method includes the steps of: providing a plurality of lessons, each of which contains article information, new words, and stroke information of each of the new words; selectively loading one of the lessons and displaying the article information and new words therein; after clicking one of the new words, generating a playing area to play the stroke information corresponding to the clicked new word and generating a following area to detect and display user's input strokes therein; and after the input strokes detected in the following area, comparing the input strokes with the stroke information of the clicked new word to generate a score information.

The disclosed system and method disclosed above differ from the prior art in that the invention enables the user to browse article information and new words thereof. By clicking one of the new words, the user can learn the corresponding stroke information. Moreover, the invention detects user's input strokes and compares with the stroke information to perform an evaluation.

Through the above-mentioned technique, the invention can increase the efficiency of learning new words.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed lesson learning system;

FIG. 2 is a flowchart of the disclosed lesson learning method;

FIG. 3 is a schematic view of the learning window of the invention;

FIG. 4 is a schematic view of the article information and the new words contained in the loaded lesson according to the invention;

FIGS. 5 and 6 are schematic view of using the cursor to write in the following area of the invention; and

FIG. 7 is a schematic view of scoring according to the invention.

### DETAILED DESCRIPTION OF THE INVENTION

The present invention will be apparent from the following detailed description, which proceeds with reference to the accompanying drawings, wherein the same references relate to the same elements.

Those Chinese characters shown in the drawings are just mentioned for describing the embodiments and are substantially irrelevant to any technical matters.

Before explaining the disclosed lesson learning system and method, we first define terms used herein. The lesson referred herein includes article information, new words, and stroke information of each of the new words. The stroke information includes name of stroke, range of stroke, and order of stroke. For example, suppose the new word is ‘left-falling stroke (in Chinese)’, then the stroke information includes the name of the ‘left-falling’ stroke, ‘left-falling stroke (in Chinese calligraphy)’ (meaning a stroke from the upper right part to the lower left part), the range of the stroke (a two-dimensional planar area with coordinates), and the order of stroke (which stroke in the new word, a number). Besides, each new word can further have the corresponding phonetic information. In that case, the phonetic information is displayed along with the new word.

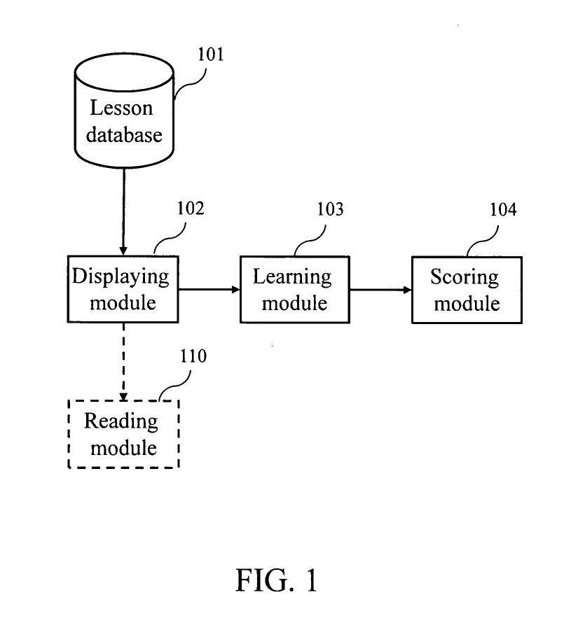

Please refer to FIG. 1 for the system block diagram of the disclosed lesson learning system. The system includes: a lesson database 101, a displaying module 102, a learning module 103, and a scoring module 104. The lesson database 101 stores several lessons, each of which contains article information, new words therein, and the stroke information of each of the new words. In practice, the lesson database 101 can be implemented by a relational database or a document file. It may even allow the user to add, edit or delete information in the lessons.

The displaying module 102 allows the user to selectively load one of the lessons and displays the article information and new words therein. In practice, the displaying module 102 generates a learning window to show the article information and new words of the lesson. This will be detailed later.

After the user clicks one of the new words, the learning module 103 generates a playing area to play the stroke information thereof and generates a following area to detect and display input strokes entered by the user therein using the cursor. For example, suppose the user selects the new word ‘plant (in Chinese)’. The learning module 103 then generates the playing area and the following area. The playing area plays the stroke information of the selected new word ‘plant (in Chinese)’. The following area continuously detects and displays any input stroke. For example, if the user presses the left key of the mouse and moves, then the system detects the cursor coordinates of the entire process to form a stroke and displays the result.

After the following area detects the input strokes, the scoring module 104 compares them with the stroke information of the selected new word, thereby generating a score information. In practice, the input strokes and the stroke information both contain the name of stroke, the range of stroke, and the order of stroke. Therefore, the score information can be produced according to the similarity and can be a number, symbol or words. For example, the invention compares the stroke ranges of the corresponding strokes (with the same stroke name and order) in the input strokes and the stroke information. When there is more overlap between the two strokes, the similarity is determined to be higher. In addition, the invention can also compare the stroke name and the stroke order between the input strokes and the stroke information. It may even provide suggestions along with the score information for the similarity in the stroke range and the stroke order. For example, a low similarity in the stroke range means that the word is not written beautifully. The system can then make a suggestion to the user for writing the word more carefully. It should be mentioned that the invention does not impose any restriction in the determination method of the similarity.

Moreover, the disclosed lesson learning system can further include a reading module 110 that uses a text-to-speech (TTS) engine to convert a loaded article into voice and plays it. In practice, the TTS engine can be used to play the sound of a new word selected by the user. Since the TTS engine belongs to the prior art, it is not further described herein.

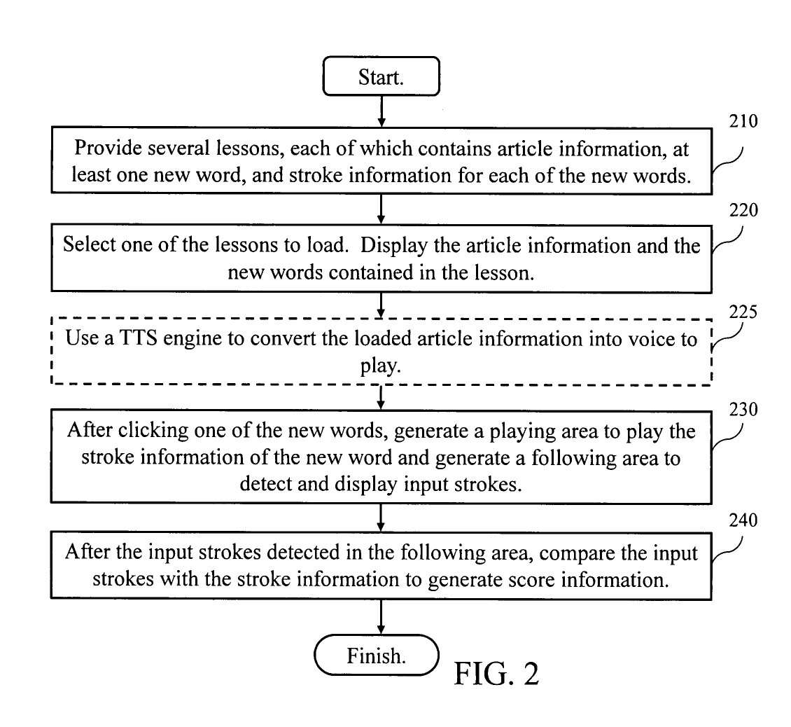

Please refer to FIG. 2 for the flowchart of the disclosed lesson learning method. The method includes the steps of: providing a plurality of lessons, each of which contains article information, new words, and stroke information of each of the new words (step 210); selectively loading one of the lessons and displaying the article information and new words therein (step 220); after clicking one of the new words, generating a playing area to play the stroke information corresponding to the clicked new word and generating a following area to detect and display user's input strokes therein (step 230); after the input strokes detected in the following area, comparing the input strokes with the stroke information of the clicked new word to generate a score information (step 240). Through the above-mentioned steps, the invention displays the article information and the new words therein for the user to browse. The user can click a new word to learn the corresponding stroke information. The invention further detects input strokes and compares them with the stroke information for scoring. Besides, the invention can include the step of using a TTS engine to convert the loaded article information into voice and playing the voice after step 220 (step 225). This part will be detailed later.

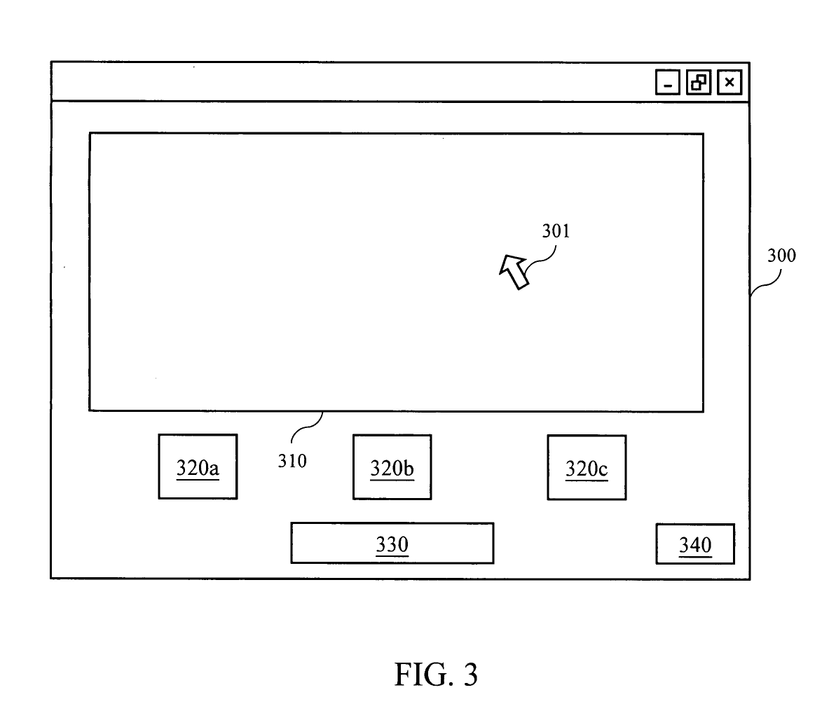

Please refer to FIGS. 3 to 7 for an embodiment of the invention. FIG. 3 shows a schematic view of the learning window of the invention. The learning window 300 includes: an article display area 310, new word display areas 320a to 320c, a selecting element 330, and a reading element 340. In practice, the displaying module 102 can generate the learning window 300 to display one lesson in the lesson database 101. The article information is shown in the article display area 310, and the new words are shown in the new word display areas (320a to 320c). It should be mentioned that the number of the new word display area can be adjusted according to the number of new words in the lesson. Suppose a particular lesson contains two new words. Then the learning window 300 only has the new word display areas 320a and 320b. Besides, if the new words also have the corresponding phonetic information, then it is displayed along with the new words in the new word display areas 320a and 320b.

In addition, the learning window 300 also allows the user to operate using the cursor 301. For example, the user can use the cursor to click the selecting element 330 in the learning window 300 to select any particular article in the lesson database 101. After the lesson is loaded, the user can click the reading element 340 using the cursor 301 to convert the article information into voice to play. However, the invention does not restrict the number and types of elements in the learning window 300.

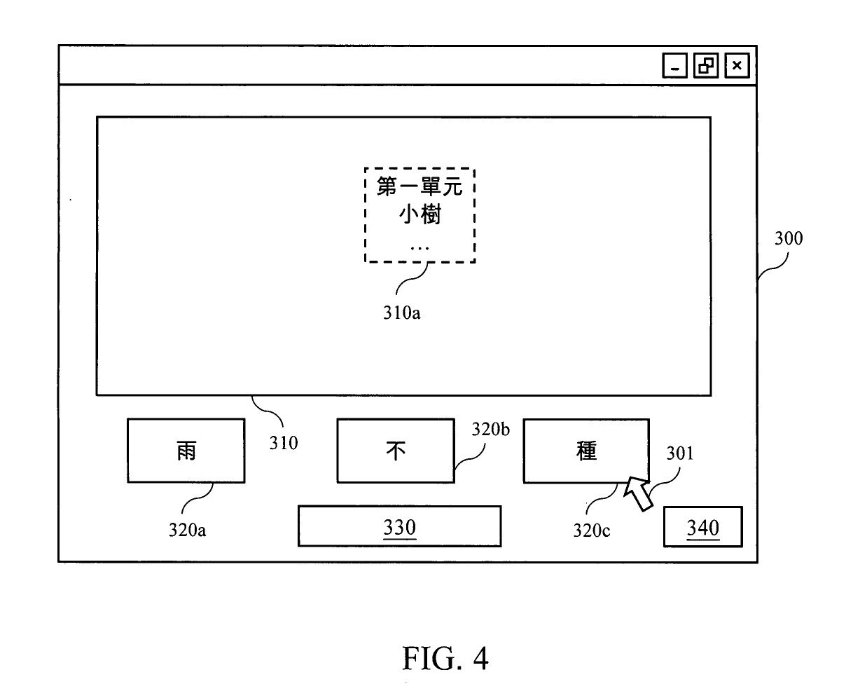

Please refer to FIG. 4 for a schematic view of the article information and the new words therein when the invention displays the loaded lesson. When the user wants to learn a lesson, he can use the displaying module 102 to generate the learning window 300 for showing one lesson in the lesson database 101. Suppose the article information contained in the lesson is ‘First Unit: A small tree . . . (in Chinese)’. The new words are ‘plant (in Chinese)’, ‘not (in Chinese)’, and ‘rain (in Chinese)’, and the stroke information of them. The displaying module 102 displays the article information ‘First Unit: A small tree . . . (in Chinese)’ in the article display area 310, and displays each of the new words in a distinct new word display areas (320a to 320c). In this case, the user can use the cursor 301 to click the selecting element 330, switching among different lessons for display. Alternatively, the user can click the reading element 340 to convert the article information 310a into voice to play using the reading module 110. If the user wants to learn the new words, he can click one of the new word display areas (320a to 320c) using the cursor 301. For example, if the user wants to learn the new word ‘plant (in Chinese)’, then he can use the cursor 301 to select the new word display area 320c.

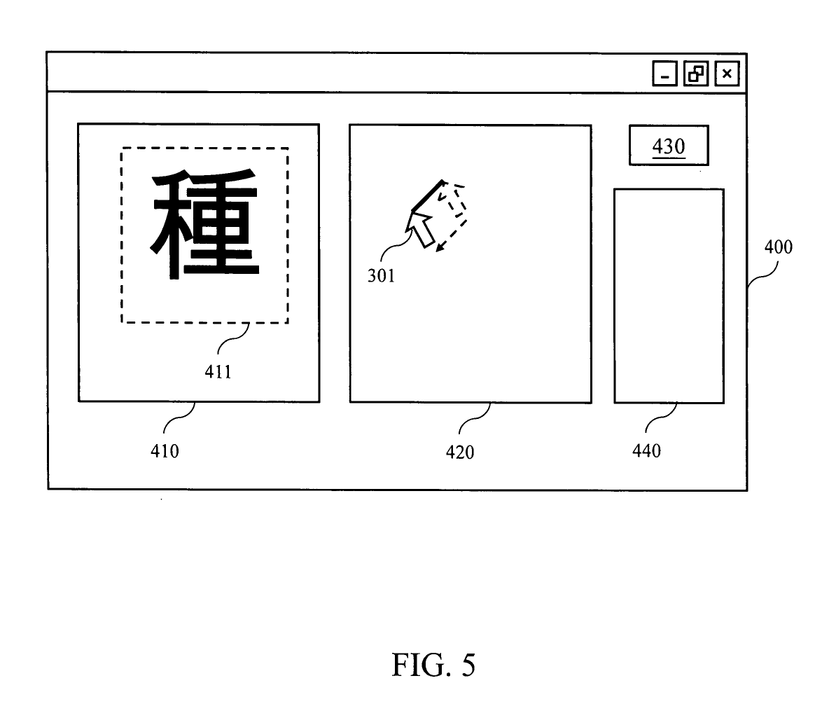

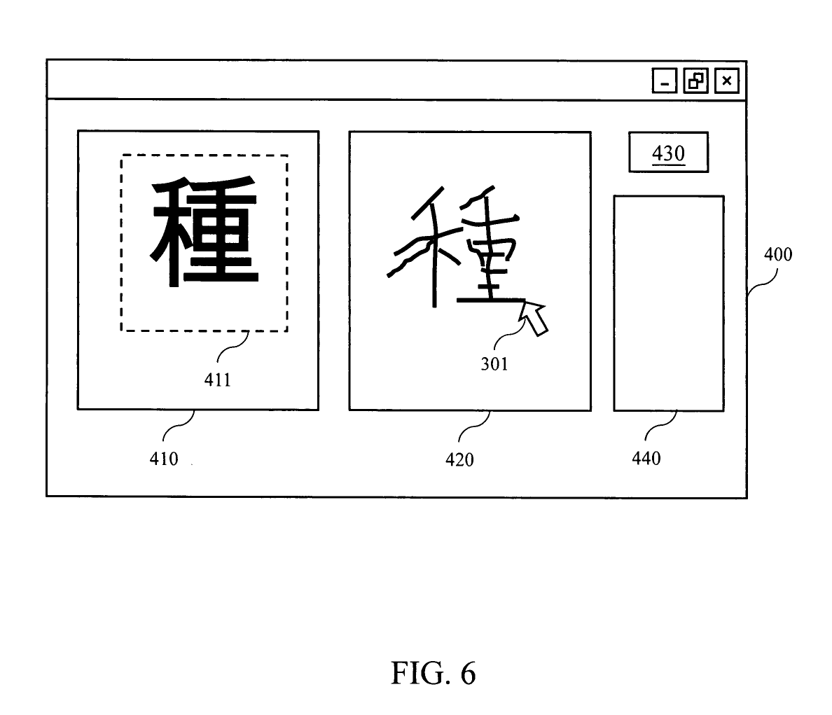

FIGS. 5 and 6 are schematic views showing that the user uses the cursor to write in the following area according to the invention. Please first refer to FIG. 5. In the above-mentioned example, when the user clicks the new word display area 320c, the learning module 103 generates a playing area 410 to play the stroke information corresponding to the clicked new word, and generates a following area 420 to detect the operation of the cursor 301 therein as input strokes. In practice, the learning module 103 can generate a following window 400 to simultaneously present the playing area 410 and the following area 420. Besides, the following window 400 can further include a scoring element 430 and a score display area 440 for scoring and showing the score information. This part will be detailed later.

The method of playing the stroke information in the playing area 410 can be a dynamical video 411 using the information of the stroke ranges and orders. For example, suppose the range of a stroke is a series of coordinates ‘(5,5)’, ‘(6,5)’, ‘(7,5)’, . . . , and ‘(15,5)’, and the order of the stroke is ‘1’. Then the stroke is played in the playing area 410 as the first stroke, following in sequence the coordinates ‘(5,5)’, ‘(6,5)’, ‘(7,5)’, . . . , and ‘(15,5)’ (if the stroke order is ‘2’, then it is played as the second stroke, and so on). The corresponding pixels are highlighted by a prominent color. It should be mentioned that several coordinates can be shown at the same time. For example, the stroke range with coordinates ‘(5,5)’ & ‘(6,5)’ means that the pixels at these two coordinates are highlighted by a prominent color simultaneously. Here the symbol ‘&’ is used to represent a simultaneous display of the two coordinates. However, the invention does not have any restriction on this. Besides, the playing method can be (a) writing the new word stroke by stroke, (b) writing the radical of the new word first and then the rest, or (c) directly playing the entire new word.

Since the playing area 410 plays the stroke information and presents it in a dynamical video, the user can use the cursor 301 to write the new word in the following area 420 after browsing, as shown in FIG. 5, until he completes the new word ‘plant (in Chinese)’, as shown in FIG. 6. During this writing process, the following area 420 continuously detects and displays the input strokes. At the same time, the invention determines the name, range, and order of each stroke. For example, this determination is based on all of the coordinates traversed by the cursor between the times of pressing and releasing the left key of the mouse. For example, if the coordinates go from the upper right part to the lower left part, then it is determined as a ‘left-falling stroke’ (in Chinese calligraphy). All of the coordinates form the stroke range. The order or stroke is incremented by ‘1’ each time the left key is pressed and released.

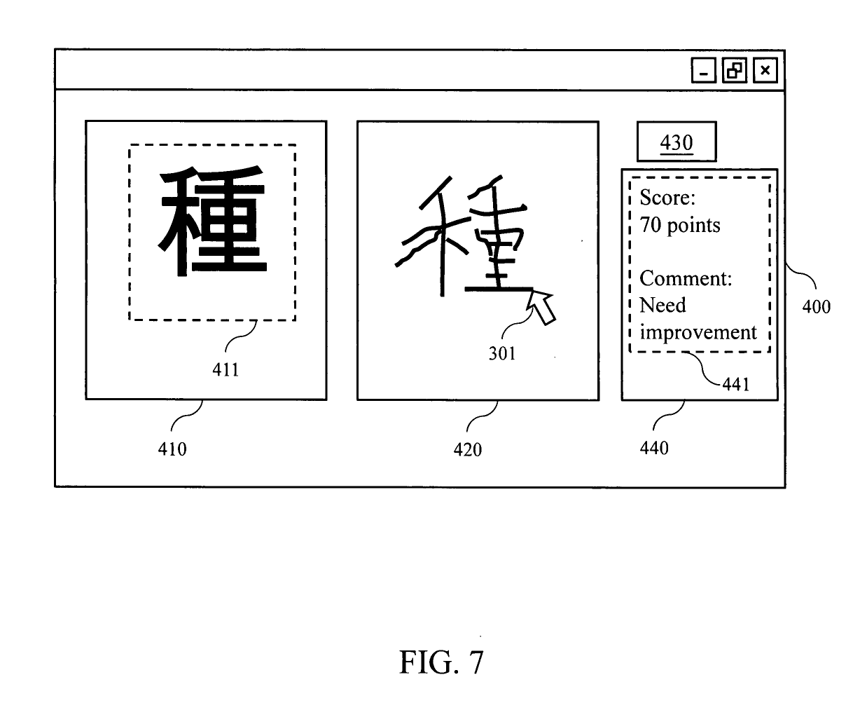

Please refer to FIG. 7 for a schematic view of using the invention for evaluation. As mentioned before, the user can use the following area 420 to learn how to write a new word. After the user completes a new word, he can use the cursor 301 to click the scoring element 430 for getting a score information. In this case, the scoring module 104 compares the input strokes detected in the following area 420 and the stroke information of the selected new word ‘plant (in Chinese)’. For example, the strokes of the same stroke name and stroke order in the input strokes and the stroke information are compared. More (less) overlap between two corresponding strokes means a higher (lower) similarity. The comparison result is then used to generate a score information. For example, a 100% similarity gives the score information ‘Score: 100 points; comment: perfect’. A similarity of 70% gives the score information ‘Score: 70 points; comment: need improvement’. Following the above example, suppose the generated score information 441 is ‘Score: 70 points; comment: need improvement’. Then the score information 441 is shown in the score display area 440. It should be emphasized the invention does not impose any restriction on the contents of the score information. In practice, the score information generated based on similarity can include numerical, symbol or text contents.

In summary, the invention differs from the prior art in that the invention enables the user to browse article information and new words thereof. By clicking one of the new words, the user can learn the corresponding stroke information. Moreover, the invention detects user's input strokes and compares with the stroke information to perform an evaluation. Through the above-mentioned technique, the invention can increase the efficiency of learning new words.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A lesson learning system, comprising:
a lesson database for storing a plurality of lessons, each of which contains article information, at least one new word, and stroke information for each of the new words;
a displaying module for selectively loading one of the lessons and displaying the article information and new words therein;
a learning module for, after one of the new words selected, generating a playing area for playing the stroke information of the selected new word and generating a following area for detecting and displaying input strokes therein; and
a scoring module for, after the input strokes detected in the following area, comparing the input strokes with the stroke information of the selected new word to generate a score information.

2. The lesson learning system of claim 1, wherein each of the new words has corresponding phonetic information that is displayed at the same time with the new word.

3. The lesson learning system of claim 1, wherein the stroke information and the input strokes contain stroke names, stroke ranges, and stroke orders.

4. The lesson learning system of claim 1, wherein the score information is a number, symbol or words generated according to the similarity between the input strokes and the stroke information.

5. The lesson learning system of claim 1 further comprising a reading module that uses a text-to-speech (TTS) engine to convert the article information of the loaded lesson into voice and play the voice.

6. A lesson learning method, comprising the steps of:
providing a plurality of lessons, each of which contains article information, new words, and stroke information of each of the new words;
selectively loading one of the lessons and displaying the article information and new words therein;
after clicking one of the new words, generating a playing area to play the stroke information corresponding to the clicked new word and generating a following area to detect and display user's input strokes therein; and
after the input strokes detected in the following area, comparing the input strokes with the stroke information of the clicked new word to generate a score information.

7. The lesson learning method of claim 6, wherein each of the new words has corresponding phonetic information that is displayed at the same time with the new word.

8. The lesson learning method of claim 6, wherein the stroke information and the input strokes contain stroke names, stroke ranges, and stroke orders.

9. The lesson learning method of claim 6, wherein the score information is a number, symbol or words generated according to the similarity between the input strokes and the stroke information.

10. The lesson learning method of claim 6 further comprising the step of using a text-to-speech (TTS) engine to convert the article information of the loaded lesson into voice and play the voice.
